(19) United States
(12) Patent Application Publication
(10) Pub. No.: US 2017/0135141 A1
(43) Pub. Date: May 11, 2017

(54) ONE-KEY CONNECTION METHOD AND SYSTEM FOR MOBILE TERMINAL AND DISPLAY EQUIPMENT

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Peng LI, Tianjin (CN)

(21) Appl. No.: 15/248,689

(22) Filed: Aug. 26, 2016

Related U.S. Application Data
(63) Continuation of application No. PCT/CN2016/088401, filed on Jul. 4, 2016.

(30) Foreign Application Priority Data
Nov. 6, 2015 (CN) 201510756760.X

(51) Int. Cl. H04W 76/02; H04W 64/00; H04L 12/26; H04W 4/00

(52) U.S. Cl. CPC H04W 76/023; H04W 4/008; H04W 64/003; H04L 43/12; H04W 84/18

(57) ABSTRACT

An embodiment of the present disclosure discloses a one-key connection method and system for a mobile terminal and a display equipment, wherein the one-key connection method comprises the following steps: the display equipment receives a wireless fidelity probe request frame which is broadcast by the mobile terminal, and determines whether content of an identity identification field which is carried in the wireless fidelity probe request frame is identical to that of preset identification; and if yes, the display equipment sends to the mobile terminal a wireless fidelity probe response frame after receiving an instruction command for a user to confirm the Miracast connection, so that the mobile terminal triggers the Miracast connection with the display equipment.

### CROSS-REFERENCE TO RELATED APPLICATIONS

This application is a continuation of International Application No. PCT/CN2016/088401 filed on Jul. 4, 2016, which is based upon and claims priority to Chinese Patent Application No. 201510756760.X, entitled “ONE-KEY CONNECTION METHOD AND SYSTEM FOR MOBILE TERMINAL AND DISPLAY EQUIPMENT”, filed on Nov. 6, 2015, the entire contents of which are incorporated herein by reference.

### TECHNICAL FIELD

The disclosure relates to the technical field of communications, in particular to a one-key connection method and system for a mobile terminal and display equipment.

### BACKGROUND

Miracast is a Wi-Fi CERTIFIED Miracast™ certification project, which was announced to launch by Wi-Fi Alliance on Sep. 19, 2012. Miracast equipment provides simplified discovery and setting, and a user can quickly transmit videos from equipment to equipment. The user can project video content displayed on a mobile phone, a tablet computer or a notebook which has passed the Miracast certification onto a receiving device (such as a TV set, a projector or a display) which supports Miracast technology in a wireless manner. The video content what the user watches on the mobile phone, the tablet computer or the notebook is identical to that on the TV set, the projector or the display. The Miracast function is called as wireless display in much intelligent equipment.

Miracast forms connection by means of Wi-Fi CERTIFIED Wi-Fi Direct™, and allows for point-to-point interconnection of equipment in a wireless network without a wireless router. However, the actual operation process for the Miracast connection of two pieces of Miracast equipment such as the mobile phone and the TV set seems to be rather complicated. Taking the mobile phone and the TV set as an example, when the TV set serves as a receiving terminal of the video content, it is required to find a Miracast (wireless display) interface from a setting interface, start the Miracast function and wait for connection of the mobile phone; and likewise, it is required to find the wireless display setting interface from the setting interface of a mobile phone terminal, start the wireless display function and select the TV set for the Miracast connection, so that the operation is rather complicated.

### SUMMARY

An embodiment of the present disclosure discloses a one-key connection method and system for a mobile terminal and display equipment to solve the problem that the operation for the Miracast connection of the mobile terminal and the equipment is complicated.

The one-key connection method for the mobile terminal and the display equipment provided by the embodiment of the present disclosure includes the following steps:

the display equipment receives a wireless fidelity probe request frame which is broadcast by the mobile terminal, and determines whether content of an identity identification field which is carried in the wireless fidelity probe request frame is identical to that of preset identification; and

if yes, the display equipment sends to the mobile terminal a wireless fidelity probe response frame after receiving an instruction command for a user to confirm the Miracast connection, so that the mobile terminal triggers the Miracast connection with the display equipment.

Correspondingly, an embodiment of the present disclosure further provides a one-key connection method for a mobile terminal and display equipment, including the following steps:

the mobile terminal receives the wireless fidelity probe response frame from the display equipment and confirms that the display equipment has accepted the Miracast connection according to the wireless fidelity probe response frame after the mobile terminal sends the wireless fidelity probe request frame through the broadcast, wherein both the wireless fidelity probe request frame and the wireless fidelity probe response frame carry the identity identification field; and

the mobile terminal sends to the display equipment a wireless fidelity direct frame, which carries the identity identification field to complete the one-key Miracast connection between the mobile terminal and the display equipment.

Correspondingly, an embodiment of the present disclosure further provides display equipment, which includes: at least one first processor; and a first memory communicably connected with the at least one first processor for storing instructions executable by the at least one first processor, wherein execution of the instructions by the at least one first processor causes the at least one first processor to:

receive a wireless fidelity probe request frame which is broadcast by the mobile terminal, and determines whether content of an identity identification field which is carried in the wireless fidelity probe request frame is identical to that of preset identification; and

send to the mobile terminal a wireless fidelity probe response frame after receiving an instruction command for a user to confirm the Miracast connection if the content of the identity identification field which is carried in the wireless fidelity probe request frame is identical to that of the preset identification, so that the mobile terminal triggers the Miracast connection with the display equipment.

Correspondingly, an embodiment of the present disclosure provides a mobile terminal, which includes at least one second processor; and a second memory communicably connected with the at least one second processor for storing instructions executable by the at least one second processor, wherein execution of the instructions by the at least one second processor causes the at least one second processor to:

receive the wireless fidelity probe response frame from the display equipment and confirms that the display equipment has accepted the Miracast connection according to the wireless fidelity probe response frame after the mobile terminal sends the wireless fidelity probe request frame through the broadcast, wherein both the wireless fidelity probe request frame and the wireless fidelity probe response frame carry the identity identification field; and

send to the display equipment a wireless fidelity direct frame, which carries the identity identification field to complete the one-key Miracast connection between the mobile terminal and the display equipment.

Correspondingly, an embodiment of the present disclosure further provides a connection system, which includes the display equipment according to the embodiment of the present disclosure and the mobile equipment according to the embodiment of the present disclosure.

Correspondingly, an embodiment of the present disclosure also provides a computer readable storage medium in which a program for executing the method according to the embodiment of the present disclosure is recorded.

According the one-key connection method and system for the mobile terminal and the display equipment provided by the embodiment of the present disclosure, a Miracast key is arranged on the mobile terminal, it is not required to enable the wireless display function in a setting interface, search corresponding equipment and select the equipment for the Miracast connection, and opposite Miracast equipment (such as the display equipment) can be found and the Miracast connection can be triggered automatically by pressing the Miracast key only; after the Miracast key on the mobile terminal is pressed, the mobile terminal enables the Miracast connection function, and broadcasts to the outside the wireless fidelity probe request frame which carries the identity identification field; the display equipment will pop up a dialogue box for the user to confirm the Miracast connection after receiving the wireless fidelity probe request frame which is broadcast by the mobile terminal and confirming that the content of the identity identification field in the wireless fidelity probe request frame is identical to that of the preset identification; after the user's confirmation, the display equipment sends to the mobile terminal the wireless fidelity probe response frame which also carries the identity identification field, the mobile terminal confirms that the display equipment has accepted the Miracast connection and triggers the Miracast connection with the display equipment after receiving the wireless fidelity probe response frame. In the above process, it is not required to enable the wireless display function and wait for the connection in the setting interface of both the mobile terminal and the display equipment, so that user's operation steps are reduced, the difficulty in realizing the Miracast connection is decreased, and user experience is improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow chart of a one-key connection method for a mobile terminal and display equipment according to one embodiment of the present disclosure.

FIG. 2 is a structural schematic diagram of a one-key connection system for a mobile terminal and display equipment according to another embodiment of the present disclosure.

FIG. 3 illustrates a block diagram of a computing device used to execute the method according to the present disclosure.

FIG. 4 illustrates a memory cell used to keep or carry a program code for realizing the method according to the present disclosure.

### DETAILED DESCRIPTION

In order to make objects, technical solutions and advantages of the embodiments of the present disclosure more apparent, the technical solutions in the embodiments of the present disclosure will be described in a clearly and fully understandable way in connection with the drawings related to the embodiments of the present disclosure. It is obvious that the described embodiments are just a part but not all of the embodiments of the present disclosure. Based on the described embodiments herein, those of ordinary skill in the art can obtain other embodiment(s), without any inventive work, which should be within the scope of the present disclosure.

### First Embodiment

A one-key connection method for a mobile terminal and display equipment provided by the first embodiment of the present disclosure is described in detail.

According to the embodiment, both the mobile terminal and the display equipment are in support of Miracast technology, wherein a Miracast key is arranged on the mobile terminal.

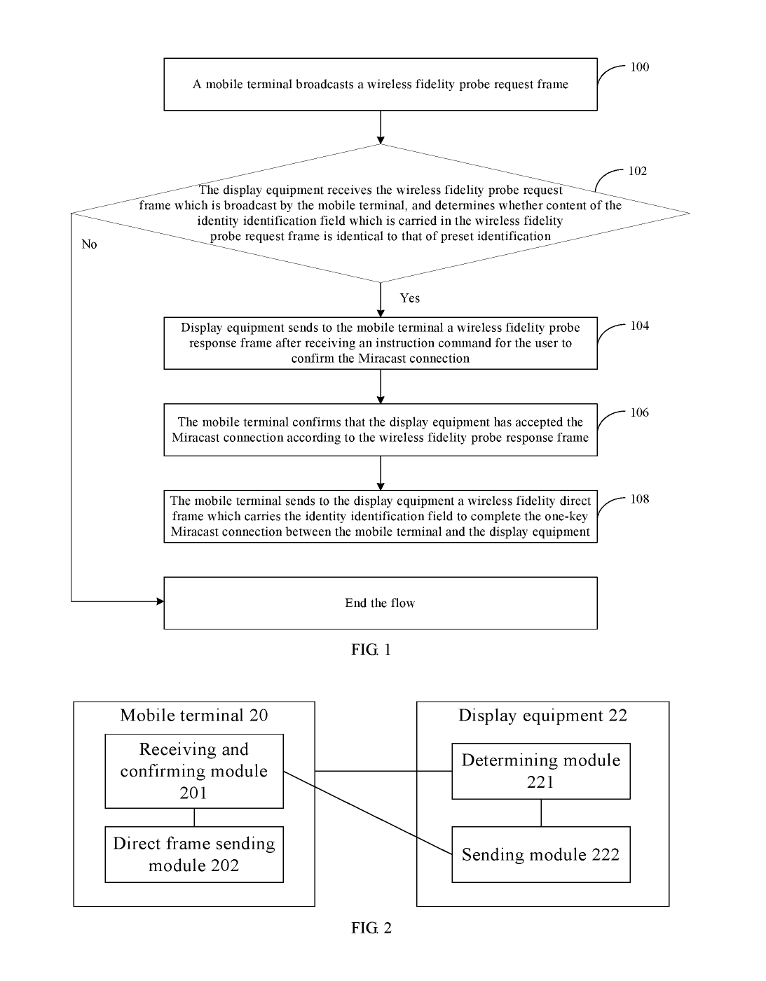

With reference to FIG. 1, which illustrates a step flow chart of a one-key connection method for a mobile terminal and display equipment according to one embodiment of the present disclosure.

Step 100 that the mobile terminal broadcasts a wireless fidelity probe request frame.

After the Miracast key of the mobile terminal is pressed or clicked, a frame of the mobile terminal will enable a wireless fidelity indication (Wi-Fi direct) function, add a wireless fidelity peer-to-peer network field and an identity identification field into the wireless fidelity probe request frame, and sends the wireless fidelity probe request frame in a broadcasting manner.

Wherein, the wireless fidelity peer-to-peer network field exists by default when the mobile terminal enables the Miracast function.

In a preferable embodiment of the present disclosure, the identity identification field may include an OUI (Organizationally Unique Identifier) and a value, wherein unique identifying information is filled in the OUI and the value.

Step 102 that the display equipment receives the wireless fidelity probe request frame which is broadcast by the mobile terminal, and determines whether content of the identity identification field which is carried in the wireless fidelity probe request frame is identical to that of preset identification; if yes, execute step 104; if not, end the flow.

In a preferable embodiment of the present disclosure, the display equipment receives the wireless fidelity probe request frame and reports the wireless fidelity probe request frame to a UI (User Interface), and the UI pops up a prompt dialogue box to prompt the user whether to accept the Miracast connection or not.

Step 104 that the display equipment sends to the mobile terminal a wireless fidelity probe response frame after receiving an instruction command for the user to confirm the Miracast connection.

The user confirms to accept the Miracast connection, and the frame of the display equipment is triggered to enable the Wi-Fi direct function and send the wireless fidelity probe response frame to the mobile terminal.

In a preferable embodiment of the present disclosure, the wireless fidelity probe response frame includes a wireless fidelity peer-to-peer network field and an identity identification field.

It should be noted that content of the identity identification field in the wireless fidelity probe response frame is identical to that in the wireless fidelity probe request frame.

Step 106 that the mobile terminal confirms that the display equipment has accepted the Miracast connection according to the wireless fidelity probe response frame.

In a preferable embodiment of the present disclosure, the mobile terminal transmits the wireless fidelity probe response frame to the frame of the mobile terminal, confirms that the content of the identity identification field in the wireless fidelity probe response frame is identical to that in the wireless fidelity probe request frame through the frame, and confirms that the display equipment has accepted the Miracast connection.

Step 108 that the mobile terminal sends to the display equipment a wireless fidelity direct frame, which carries the identity identification field to complete the one-key Miracast connection between the mobile terminal and the display equipment.

The wireless fidelity direct frame (Wi-Fi direct) frame may include a provision discovery frame, a negotiation request frame and a negotiation confirm frame.

In conclusion, according to the one-key connection method for the mobile terminal and the display equipment provided by the embodiment of the present disclosure, the Miracast key is arranged on the mobile terminal, it is not required to enable the wireless display function in a setting interface, search corresponding equipment and select the equipment for the Miracast connection, and opposite Miracast equipment (such as the display equipment) can be found and the Miracast connection can be triggered automatically by pressing the Miracast key only; after the Miracast key on the mobile terminal is pressed, the mobile terminal enables the Miracast connection function, and broadcasts to the outside the wireless fidelity probe request frame which carries the identity identification field; the display equipment will pop up a dialogue box for the user to confirm the Miracast connection after receiving the wireless fidelity probe request frame which is broadcast by the mobile terminal and confirming that the content of the identity identification field in the wireless fidelity probe request frame is identical to that of the preset identification; after the user's confirmation, the display equipment sends to the mobile terminal the wireless fidelity probe response frame which also carries the identity identification field, the mobile terminal confirms that the display equipment has accepted the Miracast connection and triggers the Miracast connection with the display equipment after receiving the wireless fidelity probe response frame. In the above process, it is not required to enable the wireless display function and wait for the connection in the setting interface of both the mobile terminal and the display equipment, so that user's operation steps are reduced, the difficulty in realizing the Miracast connection is decreased, and user experience is improved.

### Second Embodiment

A one-key connection system for a mobile terminal and display equipment provided by the second embodiment of the present disclosure is described in detail.

The one-key connection system includes a mobile terminal 20 and display equipment 22. According to the embodiment, both the mobile terminal 20 and the display equipment 22 are in support of Miracast technology, wherein a Miracast key is arranged on the mobile terminal 20. The mobile terminal 20 includes a receiving and confirming module 201 and a direct frame sending module 202. The display equipment 22 includes a determining module 221 and a sending module 222.

With reference to FIG. 2, which illustrates a structural schematic diagram of a one-key connection system for a mobile terminal and display equipment according to another embodiment of the present disclosure.

Functions and relationship of the respective modules will be described in detail as follows.

The receiving and confirming module 201 is configured to receive a wireless fidelity probe response frame from the display equipment and confirms that the display equipment has accepted the Miracast connection according to the wireless fidelity probe response frame after the mobile terminal broadcasts a wireless fidelity probe request frame.

Both the wireless fidelity probe request frame and the wireless fidelity probe response frame carry an identity identification field. Content of the identity identification field in the wireless fidelity probe response frame is identical to that in the wireless fidelity probe request frame.

Preferably, the identity identification field includes an organizationally unique identifier and a value.

Preferably, the receiving and confirming module 201 transmits the wireless fidelity probe response frame to a frame of the mobile terminal, confirms that the content of the identity identification field in the wireless fidelity probe response frame is identical to that in the wireless fidelity probe request frame through the frame, and confirms that the display equipment has accepted the Miracast connection.

The direct frame sending module 202, which is configured to send to the display equipment a wireless fidelity direct frame which carries the identity identification field to complete the one-key Miracast connection between the mobile terminal and the display equipment.

The determining module 221 is configured to receive the wireless fidelity probe request frame, which is broadcast by the mobile terminal, and determine whether content of the identity identification field, which is carried in the wireless fidelity probe request frame, is identical to content of preset identification.

The sending module 222 is configured to send to the mobile terminal the wireless fidelity probe response frame after receiving an instruction command for a user to confirm the Miracast connection if the content of the identity identification field which is carried in the wireless fidelity probe request frame is identical to that of the preset identification, so that the mobile terminal triggers the Miracast connection with the display equipment.

In conclusion, according to the one-key connection system for the mobile terminal and the display equipment provided by the embodiment of the present disclosure, the Miracast key is arranged on the mobile terminal, it is not required to enable the wireless display function in a setting interface, search corresponding equipment and select the equipment for the Miracast connection, and opposite Miracast equipment (such as the display equipment) can be found and the Miracast connection can be triggered automatically by pressing the Miracast key only; after the Miracast key on the mobile terminal is pressed, the mobile terminal enables the Miracast connection function, and broadcasts to the outside the wireless fidelity probe request frame which carries the identity identification field; the display equipment will pop up a dialogue box for the user to confirm the Miracast connection after receiving the wireless fidelity probe request frame which is broadcast by the mobile terminal and confirming that the content of the identity identification field in the wireless fidelity probe request frame is identical to that of the preset identification; after the user's confirmation, the display equipment sends to the mobile terminal the wireless fidelity probe response frame which also carries the identity identification field, the mobile terminal confirms that the display equipment has accepted the Miracast connection and triggers the Miracast connection with the display equipment after receiving the wireless fidelity probe response frame. In the above process, it is not required to enable the wireless display function and wait for the connection in the setting interface of both the mobile terminal and the display equipment, so that user's operation steps are reduced, the difficulty in realizing the Miracast connection is decreased, and user experience is improved.

Device embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. Those ordinarily skilled in the art may understand and implement it without paying creative works.

Respective device embodiments of the present disclosure may be realized by hardware, software modules, which operate on one or more processor, or the combination of the hardware, and the software modules. Those skilled in the art should understand that some or all functions of some or all components in communication processing equipment according to the embodiment of the present disclosure may be realized by employing a microprocessor or a DSP (Digital Signal Processor) in practice. The present disclosure can also be realized as equipment, a device program (such as a computer program and a computer program product) used to execute a part, or all of the method described herein. According to the present disclosure, the program, which is realized in such a manner, may be stored on a computer readable medium, or may be provided with one or more signal(s). Such signal(s) may be downloaded from a website on the Internet, provided on a carrier signal or provided in any other form.

For example, the device according to the present disclosure may be applied to a computing device, wherein the computing device may conventionally include a processor and the computer program product or the computer readable medium in the form of a memory. The memory may be an electronic memory such as a flash memory, an EEPROM (Electrically Erasable Programmable Read-Only Memory), an EPROM (Electrically Programmable Read-Only Memory), hardware or a ROM (Read Only Memory), and is provided with a memory space for program codes used to execute any step of the above methods. For example, the memory space for the program codes may include respective program codes used to realize respective steps in the above-described methods. The program codes may be read from or written into one or more computer program product(s), wherein the computer program products include program code carriers such as hard disks, CDs (Compact Disk), memory cards or floppy disks. Such computer program products are generally portable or fixed memory cells, wherein each of the memory cells may be provided with a memory segment, a storage space and the like in similar arrangement with the memory in the computing device. The program codes may be compressed in an appropriate form. In general, the memory cells include computer readable codes, namely codes that may be read by the above-described processor. Such codes cause the computing device to execute the respective steps of the above-described method when operating on the computing device.

Those ordinarily skilled in the art will appreciate that all or part of steps according to the above method embodiments may be realized by the hardware in connection with a program command, and the above-described program may be stored in a computer readable memory medium. The program executes the steps according to the method embodiments in execution. The memory medium includes respective mediums (such as ROMs, RAMs (Random-Access Memory), diskettes or DVDs (Digital Video Disk) etc.) which may store the program codes.

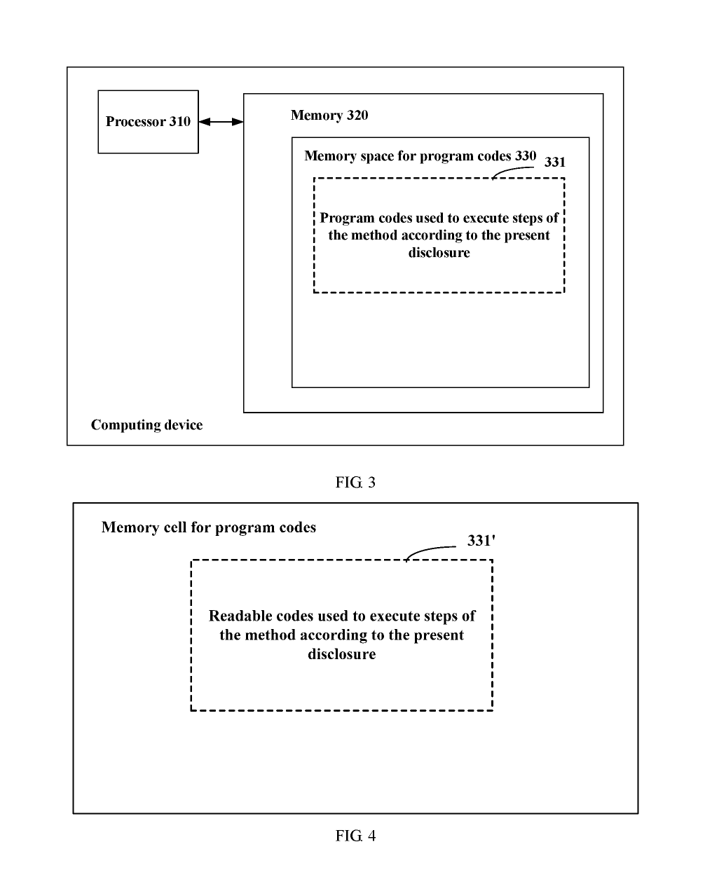

FIG. 3 illustrates a computing device that may realize a regulating method of vehicle information according to the present disclosure. The computing device (such as display equipment, mobile equipment and the like) conventionally includes a processor 310 and a program product or a readable medium in the form of a memory 320. The memory 320 may be an electronic memory such as a flash memory, an EEPROM (Electrically Erasable Programmable Read-Only Memory), an EPROM (Electrically Programmable Read-Only Memory), or a ROM (Read Only Memory), and is provided with a memory space 330 for program codes 331 used to execute any step of the above methods. For example, the memory space 330 for the program codes may include respective program codes 331 used to realize respective steps in the above-described methods. The program codes may be read from or written into one or more computer program product(s), wherein the computer program products include program code carriers such as memory cards. Such computer program products are generally portable or fixed memory cells as described with reference to FIG. 4, wherein each of the memory cells may be provided with a memory segment, a storage space and the like in similar arrangement with the memory 320 in the computing device as shown in FIG. 3. The program codes may be compressed in an appropriate form. In general, the memory cells include readable codes 331′, namely codes that may be read by the above-described processor 310. Such codes cause the processor of the computing device to execute the respective steps of the above-described method when operating on the processor of the computing device.

Finally, it should be noted that the foregoing embodiments are merely illustrative of technical solutions of the present disclosure without limitation; although the present disclosure is illustrated in detail with reference to the above embodiments, those ordinarily skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A one-key connection method for a mobile terminal and a display equipment, comprising:
the display equipment receiving a wireless fidelity probe request frame which is broadcast by the mobile terminal, and determining whether content of an identity identification field which is carried in the wireless fidelity probe request frame is identical to that of preset identification; and
if yes, the display equipment sending to the mobile terminal a wireless fidelity probe response frame after receiving an instruction command for a user to confirm a Miracast connection, so that the mobile terminal triggering the Miracast connection with the display equipment.

2. The one-key connection method according to claim 1, wherein the identity identification field comprises an organizationally unique identifier and a value.

3. The one-key connection method according to claim 1, wherein: the wireless fidelity probe response frame comprises the identity identification field; and
the content of the identity identification field in the wireless fidelity probe response frame is identical to that in the wireless fidelity probe request frame.

4. A one-key connection method for a mobile terminal and a display equipment, comprising:
the mobile terminal receiving a wireless fidelity probe response frame from the display equipment and confirming that the display equipment accepts a Miracast connection according to the wireless fidelity probe response frame after the mobile terminal sends a wireless fidelity probe request frame through a broadcast, wherein both the wireless fidelity probe request frame and the wireless fidelity probe response frame carry an identity identification field; and
the mobile terminal sending to the display equipment a wireless fidelity direct frame that carries the identity identification field to complete the one-key Miracast connection between the mobile terminal and the display equipment.

5. The one-key connection method according to claim 4, wherein the mobile terminal confirming that the display equipment accepts the Miracast connection according to the wireless fidelity probe response frame, comprising:
the mobile terminal transmitting the wireless fidelity probe response frame to a frame of the mobile terminal, confirming that the content of the identity identification field in the wireless fidelity probe response frame is identical to that in the wireless fidelity probe request frame through the frame, and confirming that the display equipment accepts the Miracast connection.

6. Display equipment, comprising:
at least one first processor; and
a first memory communicably connected with the at least one first processor for storing instructions executable by the at least one first processor, wherein execution of the instructions by the at least one first processor causes the at least one first processor to:
receive a wireless fidelity probe request frame which is broadcast by the mobile terminal, and determines whether content of an identity identification field which is carried in the wireless fidelity probe request frame is identical to that of preset identification; and
send to the mobile terminal a wireless fidelity probe response frame after receiving an instruction command for a user to confirm a Miracast connection if the content of the identity identification field which is carried in the wireless fidelity probe request frame is identical to that of the preset identification, so that the mobile terminal triggers the Miracast connection with the display equipment.

7. The display equipment according to claim 6, wherein the identity identification field comprises an organizationally unique identifier and a value.

8. The display equipment according to claim 6, wherein the wireless fidelity probe response frame comprises the identity identification field; and
the content of the identity identification field in the wireless fidelity probe response frame is identical to that in the wireless fidelity probe request frame.

9. A mobile terminal, for executing the method according to claim 4, comprising:
at least one second processor; and
a second memory communicably connected with the at least one second processor for storing instructions executable by the at least one second processor, wherein execution of the instructions by the at least one second processor causes the at least one second processor to:
receive a wireless fidelity probe response frame from display equipment and confirm that the display equipment accept a Miracast connection according to the wireless fidelity probe response frame after the mobile terminal sends a wireless fidelity probe request frame through a broadcast, wherein both the wireless fidelity probe request frame and the wireless fidelity probe response frame carry an identity identification field; and
send to the display equipment a wireless fidelity direct frame, which carries the identity identification field to complete the one-key Miracast connection between the mobile terminal and the display equipment.

10. The mobile terminal according to claim 9, wherein confirm that the display equipment accepts a Miracast connection according to the wireless fidelity probe response frame comprises:
transmit the wireless fidelity probe response frame to a frame of the mobile terminal, confirm that the content of the identity identification field in the wireless fidelity probe response frame is identical to that in the wireless fidelity probe request frame through the frame, and confirm that the display equipment accepts the Miracast connection.
